(19) United States
(12) Patent Application Publication
(10) Pub. No.: US 2017/0294795 A1
(43) Pub. Date: Oct. 12, 2017

(54) WIRELESS CHARGING DEVICE WITH DYNAMIC POWER ADJUSTMENT

(71) Applicant: VividTck Technology Ltd., Taoyuan City (TW)

(72) Inventor: Yun-Ling Liang, Taoyuan City (TW)

(21) Appl. No.: 15/096,272

(22) Filed: Apr. 11, 2016

(51) Int. Cl. H02J 7/02

(52) U.S. Cl. CPC H02J 7/025

(57) ABSTRACT

The wireless charging device contains a mobile power member. The mobile power member contains a processor, a battery module, a temperature detection module, a magnetic detection module, an adjustable power conversion module, a wireless charging module, and a digital potentiometer. The processor is electrically connected to the battery module, the temperature detection module, the digital potentiometer, and the magnetic detection module. The digital potentiometer is electrically connected to the adjustable power conversion module. The adjustable power conversion module is electrically connected to the battery module and the wireless charging module. Through the temperature detection module's detecting heat produced from the wireless charging module, the magnetic detection module's detecting variation of the magnetic flux when the mobile power member charges an adjacent portable electronic appliance, together with the algorithmic calculation of the processor, the present invention achieves appropriate thermal management and saves energy consumption for the charging process.

### BACKGROUND OF THE INVENTION

### (a) Technical Field of the Invention

The present invention is generally related to wireless charging, and more particular to a wireless charging device integrated with a mobile power and capable of dynamic power adjustment.

### (b) Description of the Prior Art

Conventional wireless charging devices provide functions of electricity storage and the charge to mobile devices. For example, Republic of China Patent No. M449399 teaches a wireless charging mobile power device. As shown its drawings, the device is capable of charging devices with a wireless reception module or through a cable.

According to this and similar teachings, they incorporate a wireless output unit having an antenna or coil. When the antenna or coil is linked with the wireless reception unit of the device to be charged, magnetic resonance is produced between antennas and eddy current is formed in the antennas, thereby producing significant amount of heat. For wireless charging devices utilizing antennas, the heating or overheating problem is almost inevitable. This has adverse impact on both the charging device and the device to be charged. On one hand, a high temperature from the heat usually causes disruption to the charging. On the other hand, a great amount of heat resulted from the continuous charging process causes significant power loss.

### SUMMARY OF THE INVENTION

The present invention therefore teaches a wireless charging device integrated with a mobile power and capable of dynamic power adjustment.

The wireless charging device contains a mobile power member. The mobile power member contains a battery module, a temperature detection module, a magnetic detection module, a processor, a digital potentiometer, an adjustable power conversion module, and a wireless charging module. The processor is electrically connected to the battery module, the temperature detection module, and the magnetic detection module. The digital potentiometer is electrically connected to the processor. The adjustable power conversion module is electrically connected to the battery module and the digital potentiometer. The wireless charging module is electrically connected to the adjustable power conversion module.

Preferably, the magnetic detection module is a Hall Effect detection module.

Preferably, the adjustable power conversion module is a DC-DC power conversion module.

Through the temperature detection module's detecting heat produced from the wireless charging module, the magnetic detection module's detecting variation of the magnetic flux when the mobile power member charges an adjacent portable electronic appliance, together with the algorithmic calculation of the processor, the present invention achieves appropriate thermal management for the charging process, saves energy consumption and reduces temperature through dynamic power adjustment.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a wireless charging device according to an embodiment of the present invention.

FIG. 2 is a schematic functional block diagram showing the interaction among various modules of the wireless charging device of FIG. 1.

FIG. 3 is a schematic diagram showing the wireless charging device of FIG. 1 operated under a wireless charging mode.

FIG. 4 is a schematic diagram showing the wireless charging device of FIG. 1 operated under a wired charging mode.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

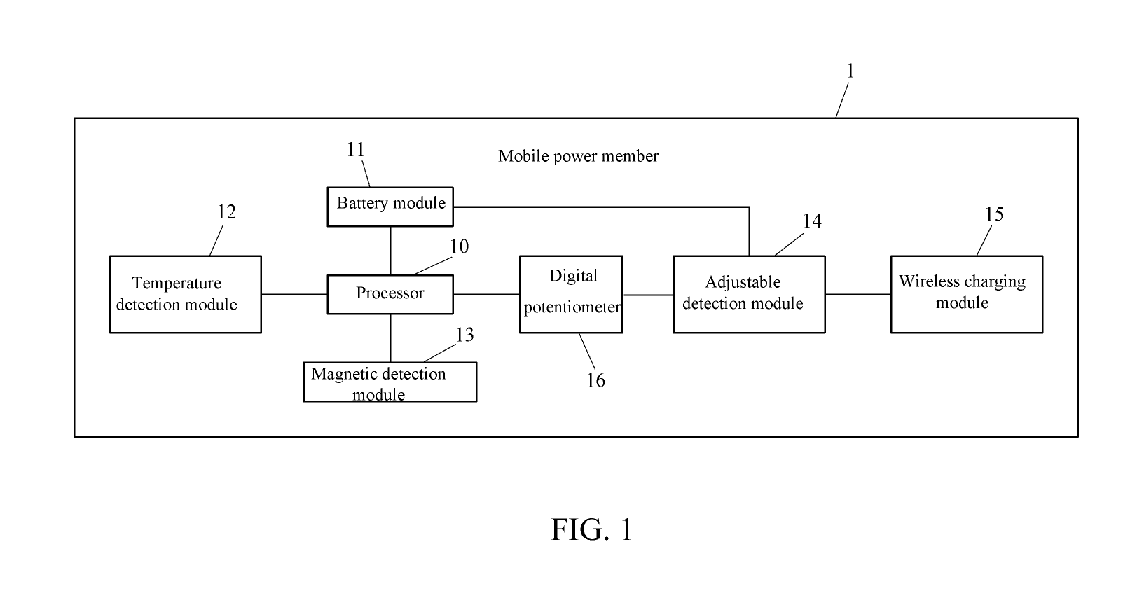

As shown FIG. 1, a wireless charging device according to an embodiment of the present invention contains a mobile power member 1.

The mobile power member 1 contains a processor 10, a battery module 11, a temperature detection module 12, a magnetic detection module 13, an adjustable power conversion module 14, a wireless charging module 15, and a digital potentiometer 16. The processor 10 is electrically connected to the battery module 11, the temperature detection module 12, the digital potentiometer 16, and the magnetic detection module 13. The digital potentiometer 16 is electrically connected to the adjustable power conversion module 14. The adjustable power conversion module 14 is electrically connected to the battery module 11 and the wireless charging module 15. In the present embodiment, the mobile power member 1 has ordinary power input terminal, power output terminal, and electricity volume indicator, etc. (not shown). However, the present invention is not limited as such. The magnetic detection module 13 may be a Hall Effect detection module which is a transducer converting varying magnetic field (magnetic flux) into voltage (signal) output. The adjustable power conversion module 14 may be DC-DC power converter which should be familiar to persons skilled in the related art and the detail is omitted here. The wireless charging module 15 usually contains transmitter and antenna.

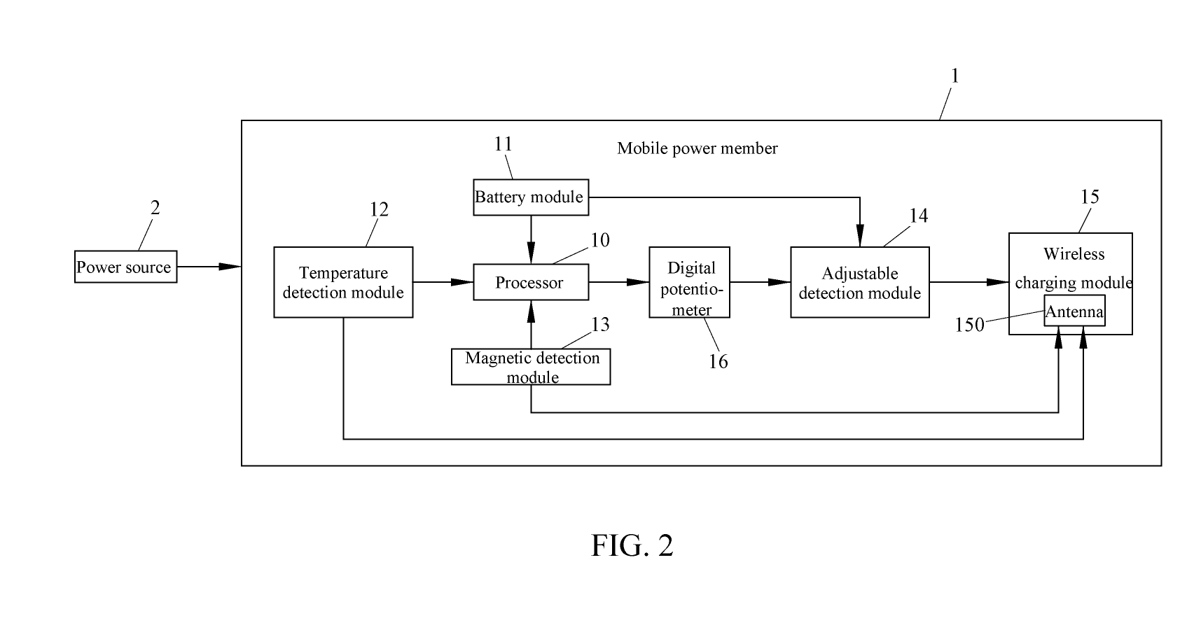

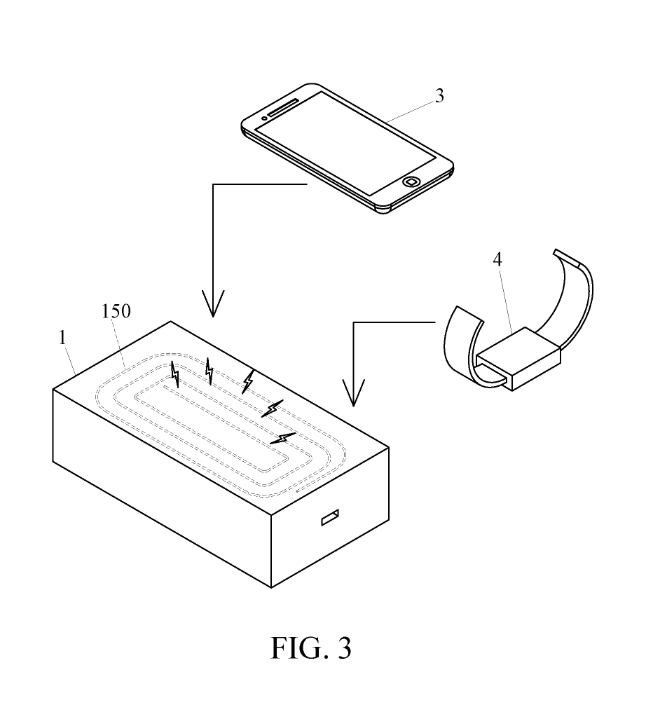

As shown in FIG. 2, the temperature detection module 12 is generally disposed adjacent to an antenna 150 of the wireless charging module 15. The magnetic detection module 13 is also positioned similarly. However, the present invention is not limited as such. As also shown in FIG. 3, in the present embodiment, the wireless charging module 15 has the antenna 150 distributed inside and across a side of the mobile power member 1. The antenna 150 operates continuously to radiate magnetic flux and is located to a primary side. The device to be charged may be portable electronic appliances capable of being wirelessly charged such as a smart phone 3, a smart bracelet 4, a smart watch, a tablet computer, etc. However, the present invention is not limited as such. The mobile power member 1 is externally connected to an AC power source 2. The AC power is converted to DC and stored in the battery module 11 which in turn powers the processor 10 and the adjustable power conversion module 14.

When there is no portable electronic appliance is close to the mobile power member, meaning no charging is conducted, as the magnetic flux from the antenna 150 at the primary side does not interact the antenna of any portable electronic appliance, the processor 10, under its algorithm, sends a digital signal to the digital potentiometer 16 so that the digital potentiometer 16 sends a variable level signal to control the adjustable power conversion module 14 to operate at a lowest power consumption condition. The adjustable power conversion module 14 adjusts the wireless charging module 15 to radiate at a lower power. The power loss and the resulted heat from the continuously operating antenna 150 is therefore reduced. The mobile power member 1 as such does not overheat and has its power loss reduced to a minimum. This is a feature of the present invention.

On the other hand, when a portable electronic appliance such as the smart phone 3 or smart bracelet 4 is close to or linked with the antenna 150, there are variations in the magnetic flux. The magnetic detection module 14 therefore detects such variations and produces a signal indicating a portable electronic appliance is nearby for wireless charging to the processor 10. The processor 10, under its algorithm, triggers the digital potentiometer 16 to send a variable level signal to control the adjustable power conversion module 14 to adjust the wireless charging module 15 to radiate at a higher power so as to quickly charge the smart phone 3 or the smart bracelet 4. This is another feature of the present invention.

After the portable electronic appliance is charged for a period of time, an amount of heat is accumulated from the antenna 150 of the wireless charging module 15. To maintain the charging process and to enhance the safety of the mobile power member 1, the temperature detection module 12 is employed to detect the accumulated heat. When the temperature detection module 12 detects a high temperature, a signal is sent to the processor 10. The processor 10, under its algorithm, triggers the digital potentiometer 16 to send a variable level signal to the adjustable power conversion module 14 to lower its power consumption. As such, not only the charging process is maintained, but also the temperature can be reduced. The portable electronic appliance is still charged but with a lowered power. This is yet another feature of the present invention.

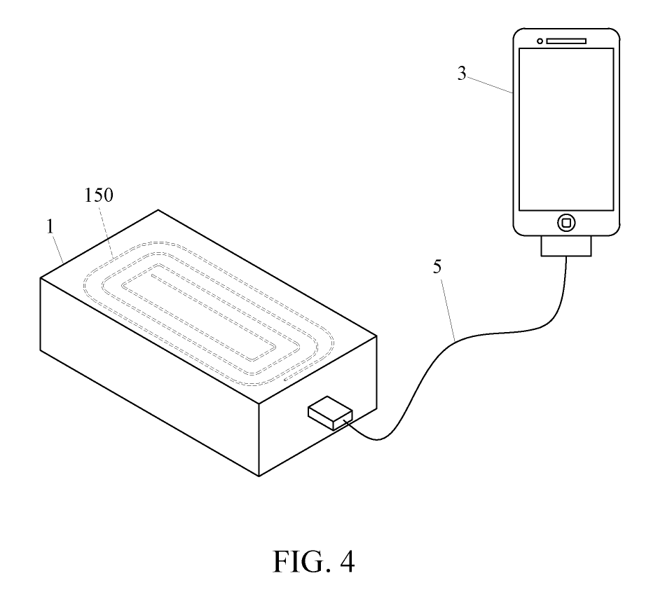

As shown in FIG. 4, the mobile power member 1 may also provide wired charging to the smart phone 3 etc. through a transmission cable 5. In other words, the wireless charging device of the present embodiment provides both wireless and wired modes of charging.

As described above, the present invention, through the temperature detection module 12's detecting heat produced from the wireless charging module 14, the magnetic detection module 13's detecting variation of the magnetic flux when the mobile power member 1 charges an adjacent portable electronic appliance, together with the algorithmic calculation of the processor 10 and the variable level signals of the digital potentiometer 16, achieves appropriate thermal management for the charging process. In the meantime, the portable electronic appliance can be charged under a high output power initially, and then reduced to a lower output power after a period of time when heat is accumulated so as to reduce temperature. When there is no appliance to be charged, the wireless charging is operated at a lowest output power so as to reduce power loss. The present invention therefore can save energy consumption and reduce temperature through dynamic power adjustment.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A wireless charging device comprising a mobile power member,
wherein the mobile power member comprises, inside the mobile power member,
a battery module;
a temperature detection module;
a magnetic detection module;
a processor electrically connected to the battery module, the temperature detection module, and the magnetic detection module;
a digital potentiometer electrically connected to the processor;
an adjustable power conversion module electrically connected to the battery module and the digital potentiometer; and
a wireless charging module electrically connected to the adjustable power conversion module.

2. The wireless charging device according to claim 1, wherein the magnetic detection module is a Hall Effect detection module.

3. The wireless charging device according to claim 1, wherein the adjustable power conversion module is a DC-DC power conversion module.
